(19) United States
(12) Patent Application Publication
(10) Pub. No.: US 2022/0245607 A1
(43) Pub. Date: Aug. 4, 2022

(54) LIGHT EMITTING APPARATUS FOR CASH VERIFICATION AND REMOTE DEPOSIT

(71) Applicant: Bank of America Corporation, Charlotte, NC (US)

(72) Inventor: Peggy J. Qualls, Oswego, IL (US)

(21) Appl. No.: 17/164,303

(22) Filed: Feb. 1, 2021

(51) Int. Cl. G06Q 20/10; G06K 9/00; G06K 9/20; H04N 5/235; H04N 5/247; G06K 9/46; H04M 1/02; G06Q 20/32; G06Q 40/02; G06K 7/10; G06K 19/06; H04W 12/06; G07D 7/20; G07D 7/00; G07D 7/004; G07D 7/12

(52) U.S. Cl. CPC G06Q 20/108; H04N 5/2257; G06K 9/2027; H04N 5/2354; G06K 9/2018; G06K 9/209; H04N 5/247; G06K 9/4652; G06K 9/4661; H04M 1/0264; G06Q 20/326; G06Q 40/02; G06K 7/10861; G06K 7/1093; G06K 19/06037; G06K 19/0614; G06K 19/06159; H04W 12/06; G07D 7/2016; G07D 7/0034; G07D 7/004; G07D 7/12; G06K 2209/01; G06K 9/00469

(57) ABSTRACT

Systems and methods for cash verification and remote deposit are provided. A method may include receiving credentials to authenticate a login to a mobile app that is associated with a first financial entity; receiving an instruction to deposit a bill of cash at a physical location associated with a second financial entity that is different from the first financial entity; illuminating a front face of the bill; capturing an image of the illuminated front face; illuminating a back face of the bill; capturing an image of the illuminated back face; extracting a first tier of features from the images; determining a denomination and/or version of the bill; when the denomination and/or version exceeds a predetermined first threshold, extracting a second tier of features; when all of the extracted features are associated with the same denomination and/or version, and all of the features that are associated with said denomination and/or version are detected, verifying the bill; and when the bill is verified and a message is received, from the second financial entity, confirming that the second financial entity received the bill, depositing an amount corresponding to the denomination in an account at the first financial entity.

### FIELD OF TECHNOLOGY

Aspects of the disclosure relate to apparatus and methods for cash verification and deposit.

### BACKGROUND OF THE DISCLOSURE

Account holders at financial institutions frequently have a need to deposit cash. It is often inconvenient to travel to a physical location of the financial institution to perform the deposit.

It would be desirable, therefore, to provide apparatus and methods for depositing cash remotely from a physical location of the financial institution with which the account holder is associated.

Furthermore, when depositing cash, especially when remote from a physical location of the financial institution, there is a risk of the cash being counterfeit. It would be further desirable, therefore, for the apparatus and methods to also verify the authenticity of the cash as part of the remote deposit.

### SUMMARY OF THE DISCLOSURE

Aspects of the disclosure relate to apparatus and methods for cash verification and remote deposit. The apparatus may include a light, a camera, and a processor. The processor may have access to a database. The database may include a set of features. Each feature from the set of features may be associated with one or more bill denominations and/or bill versions.

The processor may be configured to receive credentials to authenticate a login of a user to a mobile app. The mobile app may be associated with a first financial entity. The processor may receive an instruction from the user, via the mobile app, to deposit a bill of cash at a physical location associated with a second financial entity. The second financial entity may be different from the first financial entity.

The processor may be configured to illuminate, with the light, a front face of the bill, and capture, with the camera, an image of the illuminated front face. The processor may also be configured to illuminate, with the light, a back face of the bill, and capture, with the camera, an image of the illuminated back face.

The processor may be configured to extract, using image processing software, a first tier of features from the images. The first tier of features may include an alphanumerical serial number, an alphabetical representation of a denomination of the bill, a numerical representation of the denomination, and/or a portrait.

The processor may also be configured to determine a denomination and/or a version of the bill based on the first tier of features. When the denomination exceeds a predetermined first threshold denomination, and the version is within a predetermined range of versions, the processor may be configured to extract, using the image processing software, a second tier of features. The second tier of features may include a watermark and a security thread.

When all of the extracted features are associated with the same denomination and/or version, and all of the features that are associated with the denomination and/or version are detected, the processor may be configured to verify the bill.

When the bill is verified and a message is received, from the second financial entity, confirming that the second financial entity received the bill, the processor may be configured to deposit an amount corresponding to the denomination in an account, associated with the user, at the first financial entity.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows an illustrative system in accordance with principles of the disclosure;

FIG. 2 shows an illustrative apparatus in accordance with principles of the disclosure;

FIG. 3 shows an illustrative diagram in accordance with principles of the disclosure;

FIG. 4 shows an illustrative apparatus in accordance with principles of the disclosure;

FIG. 5 shows an illustrative flowchart in accordance with principles of the disclosure; and

FIGS. 6A-6E show illustrative bill features in accordance with principles of the disclosure.

### DETAILED DESCRIPTION OF THE DISCLOSURE

An apparatus for cash verification and remote deposit is provided. The apparatus may include a light, a camera, and a processor. The processor may run a set of computer code that is stored in non-transitory memory. A method for cash verification and remote deposit that may be executed by the computer code running on the processor is also provided.

The processor may have access to a database. The database may include a set of features. Each feature from the set of features may be associated with one or more bill denominations and/or versions. For example, an enlarged, off-center portrait of Abraham Lincoln may be one illustrative feature. That feature may be associated with a front face of a $5 bill of the “2004 Style” of Federal Reserve notes (FRNs) issued by the United States Treasury.

The processor may be configured to receive credentials to authenticate a login of a user to a mobile app. The mobile app may be associated with a first financial entity. The processor may receive an instruction from the user, via the mobile app, to deposit a bill of cash at a physical location associated with a second financial entity. The second financial entity may be different from the first financial entity. The user may, for example, have an account with the first financial institution, but the second financial institution may have a physical location that is more convenient for the user to visit for cash deposits.

The processor may be configured to illuminate, with the light, a front face of the bill, and capture, with the camera, an image of the illuminated front face. The processor may also be configured to illuminate, with the light, a back face of the bill, and capture, with the camera, an image of the illuminated back face.

The processor may be configured to extract, using image processing software, a first tier of features from the images. The first tier of features may include an alphanumerical serial number, an alphabetical representation of a denomination of the bill, a numerical representation of the denomination, and/or a portrait. Features may, in certain embodiments, be included in the first tier when they exist in all or most bill denominations and/or versions.

The processor may be configured to determine a denomination of the bill and/or a version of the bill, based at least in part on the first tier of features. Determination of the denomination may be based on the alphabetical representation and/or the numerical representation of a denomination of the bill. In some embodiments, the denomination may be based on a consensus of the numerical representation and the alphabetical representation. The denomination may also be based on a denomination that is associated, in the database, with the serial number and/or the portrait. Determination of the version may be based at least in part on the serial number, portrait, and/or any other feature.

When the denomination and/or version exceeds a predetermined first threshold denomination, and/or the version is within a predetermined range of versions (e.g., the denomination is more than $5, and the version is, at the earliest, the “2004 Style” FRN), the processor may be configured to extract, using the image processing software, a second tier of features. The second tier of features may include a watermark and/or a security thread.

As one illustrative example, a user may wish to deposit a $5 bill at a bank. The system may enable the user to visit a physical location of a different financial institution. The user may log into an app that is associated with the bank on the user's smart phone. The user may submit a request via the app to deposit the cash at the location. The app may instruct the user to hold the cash face up or place the cash face up on a surface. The surface may be any surface. The surface may be a luminous surface. The user may be instructed to hold the cash up against a light or the sun. The app may operate the light on the phone to illuminate the cash. The app may operate the camera of the phone to capture an image of the front face of the cash. The app may repeat the process for the back face.

The app may process the images and extract a first set of features. The first set of features may include text and/or numbers that correspond to a denomination. In this example, the test may read “five dollars” and the numbers may read “5.” The app may also extract a serial number. The serial number may indicate a version of the bill. Based on the denomination and/or the version, the app may further process the images to extract a second set of features. The second set may, for example, include a particular watermark. The watermark may be associated with the $5 and the version indicated by the serial number.

When all of the extracted features are associated with the same denomination and/or version, and all of the features that are associated with the denomination and/or version are detected, the processor may be configured to verify the bill. For example, if all the extracted features are associated with a $5 bill of a certain version, and all the features associated with a $5 bill of that version are detected, the bill may be verified.

When the bill is verified and a message is received, from the second financial entity, confirming that the second financial entity received the bill, the processor may be configured to deposit an amount corresponding to the denomination in an account, associated with the user, at the first financial entity.

In some embodiments, the first and second financial entities may resolve the cash deposit. For example, when the first entity receives confirmation of the deposit from the second entity, and the first entity deposits the amount into the account of the user, the first entity may transmit a bill to the second entity for the amount. The second entity, which received the actual cash, may pay the bill by wiring the amount to the first entity. The second entity may charge a convenience fee. In certain embodiments, the second entity may charge minimal or no convenience fees, and may rely on reciprocity, e.g., if a similar system is put in place for customers of the second entity to deposit cash at locations of the first entity.

In some embodiments, when the denomination exceeds a predetermined second threshold denomination, the processor may be further configured to extract, using the image processing software, a third tier of features. The third tier of features may include color shifting ink.

In certain embodiments, when the denomination exceeds a predetermined third threshold denomination, the processor may be further configured to extract, using the image processing software, a fourth tier of features. The fourth tier of features may include a 3-dimensional security ribbon.

In some embodiments, the light may be configured to emit ultraviolet (UV) rays, and the second tier of features may include a security thread that is able to be captured by the camera when illuminated by UV rays.

Certain embodiments may further include a smart phone. The light, camera, and processor may be disposed in a housing of the smart phone.

In some embodiments, the light may be a first light, and the apparatus may further include, and the method may further involve, a second light. The first light may be configured to illuminate the front face, and the second light may be configured to illuminate the back face while the first light is illuminating the front face. Illuminating the back face while the front face is being illuminated and captured by the camera may enhance the visibility of some features. For example, a watermark or security ribbon may be more visible on one side when the opposite side is illuminated.

The second light may, in certain embodiments, be configured to connect to the processor wirelessly via a Bluetooth or WiFi connection. In other embodiments, the second light may be configured to connect to the processor with a wired connection. The wired connection may include a universal serial bus (USB) port.

In some embodiments, the camera may be a first camera, and the apparatus may further include, and the method may further involve, a second camera. The first camera may be configured to capture the image of the front face, and the second camera may be configured to capture the image of the back face while the first camera is capturing the image of the front face.

In certain embodiment, the apparatus may further include, and the method may further involve a bill holder. The bill holder may include a plate against which the bill is placed, and a clip for securing the bill in place against the plate. The plate may be configured to emit light. The plate may be the second light.

Apparatus and methods described herein are illustrative. Apparatus and methods in accordance with this disclosure will now be described in connection with the figures, which form a part hereof. The figures show illustrative features of apparatus and method steps in accordance with the principles of this disclosure. It is understood that other embodiments may be utilized, and that structural, functional, and procedural modifications may be made without departing from the scope and spirit of the present disclosure.

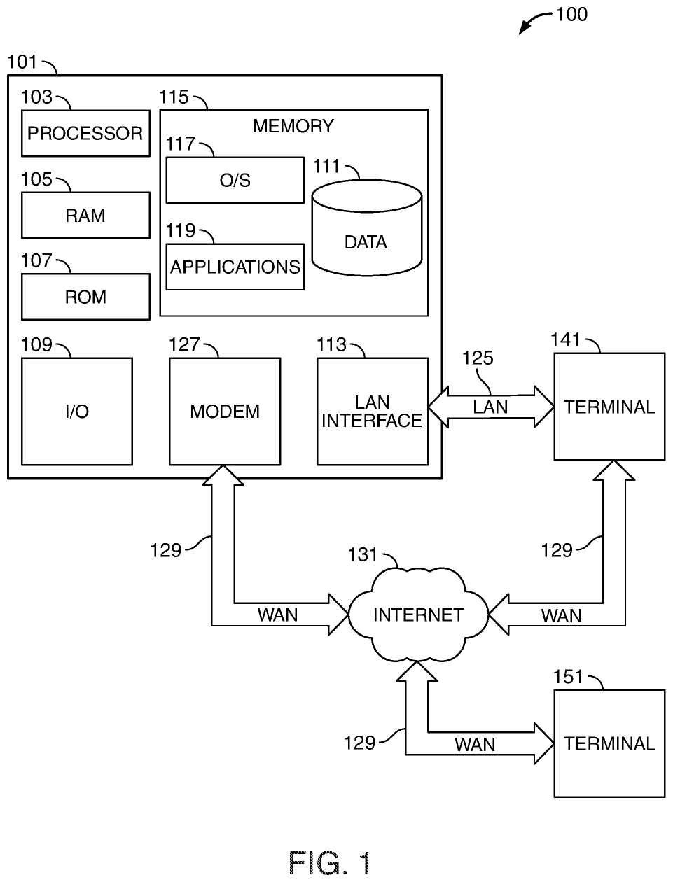

FIG. 1 shows an illustrative block diagram of system 100 that includes computer 101. Computer 101 may alternatively be referred to herein as a “server” or a “computing device.” Computer 101 may be a workstation, desktop, laptop, tablet, smart phone, or any other suitable computing device. Elements of system 100, including computer 101, may be used to implement various aspects of the systems and methods disclosed herein.

Computer 101 may have a processor 103 for controlling the operation of the device and its associated components, and may include RAM 105, ROM 107, input/output module 109, and a memory 115. The processor 103 may also execute all software running on the computer—e.g., the operating system and/or voice recognition software. Other components commonly used for computers, such as EEPROM or Flash memory or any other suitable components, may also be part of the computer 101.

The memory 115 may be comprised of any suitable permanent storage technology—e.g., a hard drive. The memory 115 may store software including the operating system 117 and application(s) 119 along with any data 111 needed for the operation of the system 100. Memory 115 may also store videos, text, and/or audio assistance files. The videos, text, and/or audio assistance files may also be stored in cache memory, or any other suitable memory. Alternatively, some or all of computer executable instructions (alternatively referred to as “code”) may be embodied in hardware or firmware (not shown). The computer 101 may execute the instructions embodied by the software to perform various functions.

Input/output (“I/O”) module may include connectivity to a microphone, keyboard, touch screen, mouse, and/or stylus through which a user of computer 101 may provide input. The input may include input relating to cursor movement. The input may relate to cash verification and remote deposit. The input/output module may also include one or more speakers for providing audio output and a video display device for providing textual, audio, audiovisual, and/or graphical output. The input and output may be related to computer application functionality. The input and output may be related to cash verification and remote deposit.

System 100 may be connected to other systems via a local area network (LAN) interface 113.

System 100 may operate in a networked environment supporting connections to one or more remote computers, such as terminals 141 and 151. Terminals 141 and 151 may be personal computers or servers that include many or all of the elements described above relative to system 100. The network connections depicted in FIG. 1 include a local area network (LAN) 125 and a wide area network (WAN) 129, but may also include other networks. When used in a LAN networking environment, computer 101 is connected to LAN 125 through a LAN interface or adapter 113. When used in a WAN networking environment, computer 101 may include a modem 127 or other means for establishing communications over WAN 129, such as Internet 131.

It will be appreciated that the network connections shown are illustrative and other means of establishing a communications link between computers may be used. The existence of various well-known protocols such as TCP/IP, Ethernet, FTP, HTTP and the like is presumed, and the system can be operated in a client-server configuration to permit a user to retrieve web pages from a web-based server. The web-based server may transmit data to any other suitable computer system. The web-based server may also send computer-readable instructions, together with the data, to any suitable computer system. The computer-readable instructions may be to store the data in cache memory, the hard drive, secondary memory, or any other suitable memory.

Additionally, application program(s) 119, which may be used by computer 101, may include computer executable instructions for invoking user functionality related to communication, such as e-mail, Short Message Service (SMS), and voice input and speech recognition applications. Application program(s) 119 (which may be alternatively referred to herein as “plugins,” “applications,” or “apps”) may include computer executable instructions for invoking user functionality related performing various tasks. The various tasks may be related to cash verification and remote deposit.

Computer 101 and/or terminals 141 and 151 may also be devices including various other components, such as a battery, speaker, and/or antennas (not shown).

Terminal 151 and/or terminal 141 may be portable devices such as a laptop, cell phone, Blackberry™, tablet, smartphone, or any other suitable device for receiving, storing, transmitting and/or displaying relevant information. Terminals 151 and/or terminal 141 may be other devices. These devices may be identical to system 100 or different. The differences may be related to hardware components and/or software components.

Any information described above in connection with database 111, and any other suitable information, may be stored in memory 115. One or more of applications 119 may include one or more algorithms that may be used to implement features of the disclosure, and/or any other suitable tasks.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, mobile phones, smart phones and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc., that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

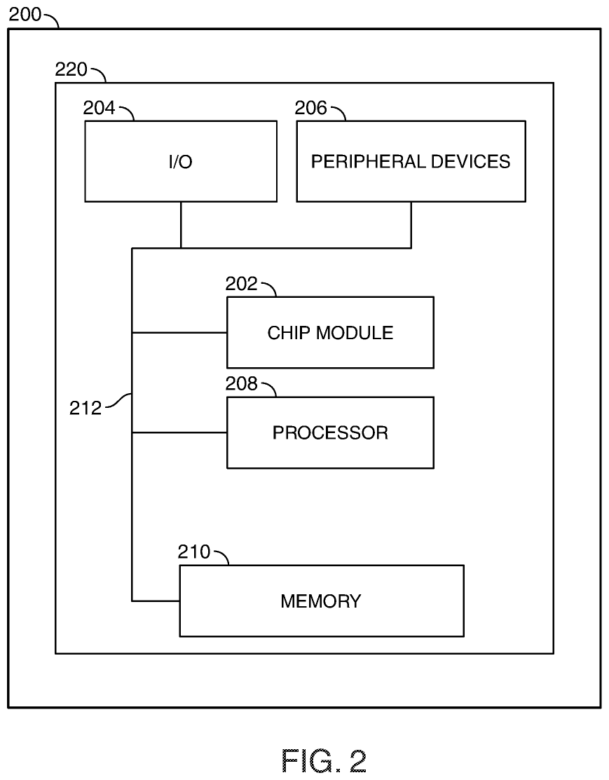

FIG. 2 shows illustrative apparatus 200 that may be configured in accordance with the principles of the disclosure. Apparatus 200 may be a computing machine. Apparatus 200 may include one or more features of the apparatus shown in FIG. 1. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable media or devices; peripheral devices 206, which may include counter timers, real-time timers, power-on reset generators or any other suitable peripheral devices; logical processing device 208, which may compute data structural information and structural parameters of the data; and machine-readable memory 210.

Machine-readable memory 210 may be configured to store in machine-readable data structures: machine executable instructions (which may be alternatively referred to herein as “computer instructions” or “computer code”), applications, signals, and/or any other suitable information or data structures.

Components 202, 204, 206, 208 and 210 may be coupled together by a system bus or other interconnections 212 and may be present on one or more circuit boards such as 220. In some embodiments, the components may be integrated into a single chip. The chip may be silicon-based.

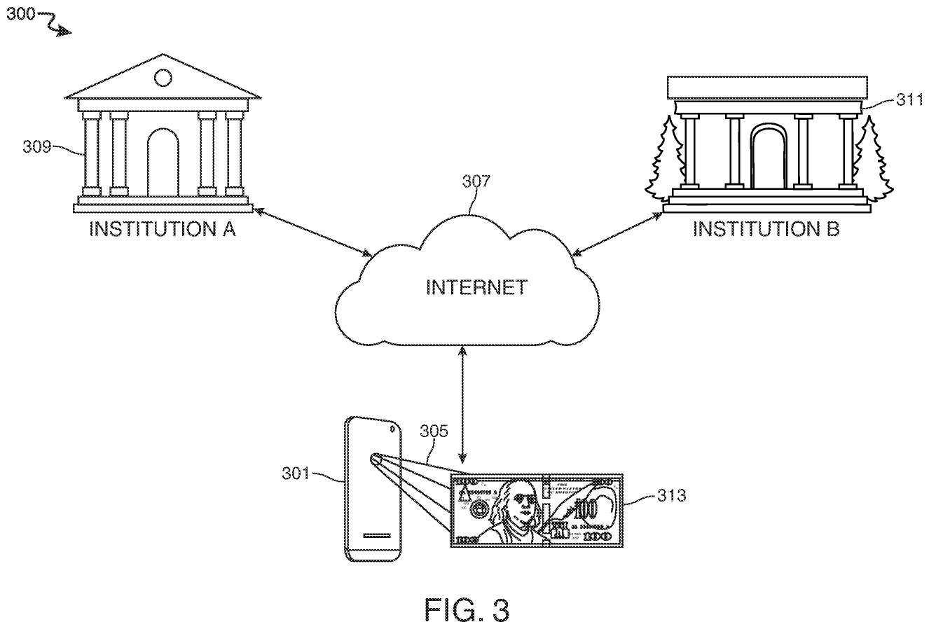

FIG. 3 shows illustrative diagram 300 in accordance with aspects of the disclosure. Diagram 300 shows smart phone 301 capturing an image of bill 303. Smart phone 301 may illuminate bill 303 with rays 305 from a light. Rays 305 may, in certain embodiments, be ultraviolet (UV) rays. Smart phone 301 may process the captured images to extract certain features. Some or all of the processing may occur locally on a processor of smart phone 301. Some or all of the processing may be executed via a connection to internet 307. For example, a processor on the phone may extract the features, and the phone may communicate with a remote server to compare the extracted features with a set of features stored in a database. The comparison may be for the purpose of verifying the authenticity of the bill.

The bill may be received and deposited at a physical location associated with Financial Institution B (311). Financial Institution B (311) may be a cash vendor. Financial Institution B (311) may transmit a message to Financial Institution A (309), via internet 307, that the bill was successfully deposited. Financial Institution A (309) may receive a message from smart phone 301, via Internet 307, that bill 303 is verified. When bill 303 is verified and confirmation is received of its deposit at Financial Institution B (311), an account at Financial Institution A (309) may be updated to reflect the deposit. On the backend, Financial Institution B (311) may then transmit to Financial Institution A (309) the amount of the deposit, in some embodiments minus a transaction fee.

In some embodiments, smart phone 301 may be configured to initially communicate directly with Financial Institution B (311) to verify and deposit the bill. Smart phone 301 may subsequently transmit to Financial Institution A (309) that the bill was verified and deposited.

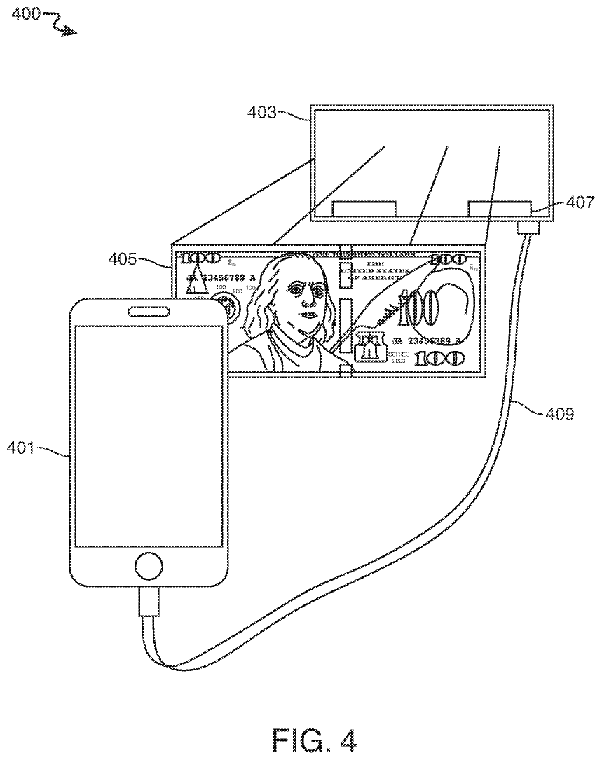

FIG. 4 shows apparatus 400 configured according to aspects of the disclosure. Apparatus 400 includes smart phone 401 and light 403. Smart phone 403 may have an integrated light that may be used to illuminate a front face of bill 405. Light 403 may be a second light that may be used to illuminate a back face of bill 405. Illuminating a back face of bill 405 may expose features that are embedded in the bill, similar to holding a bill up to the sunlight. In some embodiments, light 403 may also be a bill holder. Light 403 be substantially the shape and size of a bill. Light 403 may, for example, be flat (e.g., like a plate), and bill 405 may be placed against the plate. Light 403 may also include a clip or a tab for securing bill 405 in place against the plate. The clip or tab may be transparent so the bill may be visible in its entirety.

Light 403 may be connected to smart phone 401 with wired connection 409. Wired connection 409 may connect to the phone via a universal serial bus (USB) 411. In some embodiments (not shown), light 403 may connect to smart phone 403 with a wireless connection, such as Bluetooth or WiFi. Light 403 may connect to smart phone 401 with any other suitable wired or wireless connection.

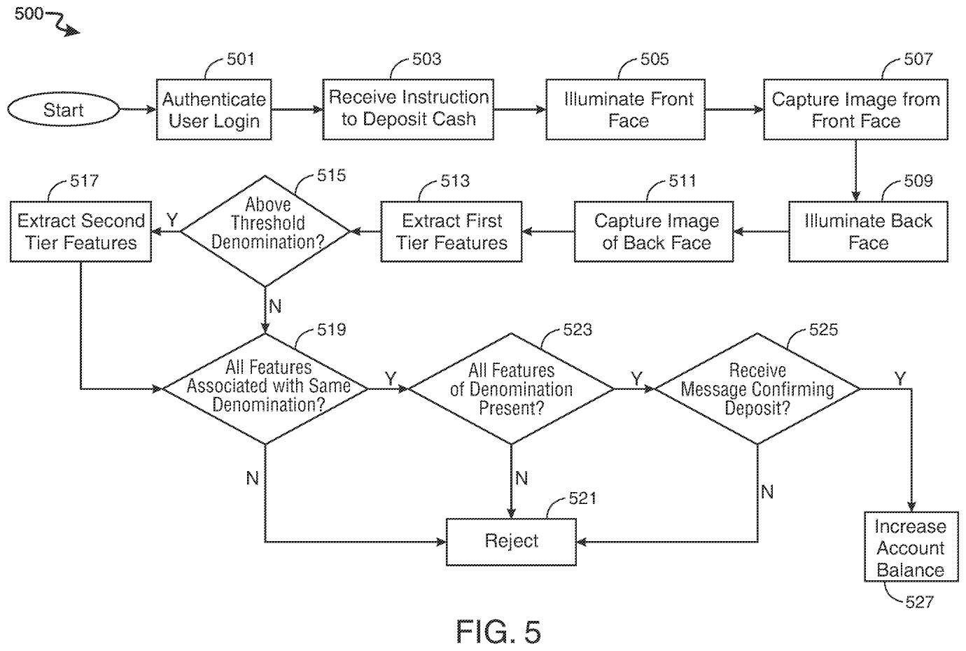

FIG. 5 shows flowchart 500 in accordance with aspects of the disclosure. Flowchart 500 begins at step 501 with authentication of a user login to an app associated with a financial institution. An instruction to deposit cash at a third party vendor may be received at 503. At 505 a front face of the bill of cash may be illuminated, and an image may be captured at 507. At 509 a rear face of the bill of cash may be illuminated, and an image may be captured at 511. A first tier of features may be extracted at 513. If a denomination and/or version exceeds a predetermined threshold, a second tier of features may be extracted at 517. If all the extracted features are associated with the same denomination and/or version at 519, and all the features associated with that denomination and/or version are present at 523, the cash may be verified. If 519 or 523 are negative, the cash deposit may not be verified, and may be rejected at 521. Once the cash deposit is verified, when a message is received from the third party vendor confirming the cash deposit at 525, the financial institution at 527 may execute a balance increase in an account associated with the user.

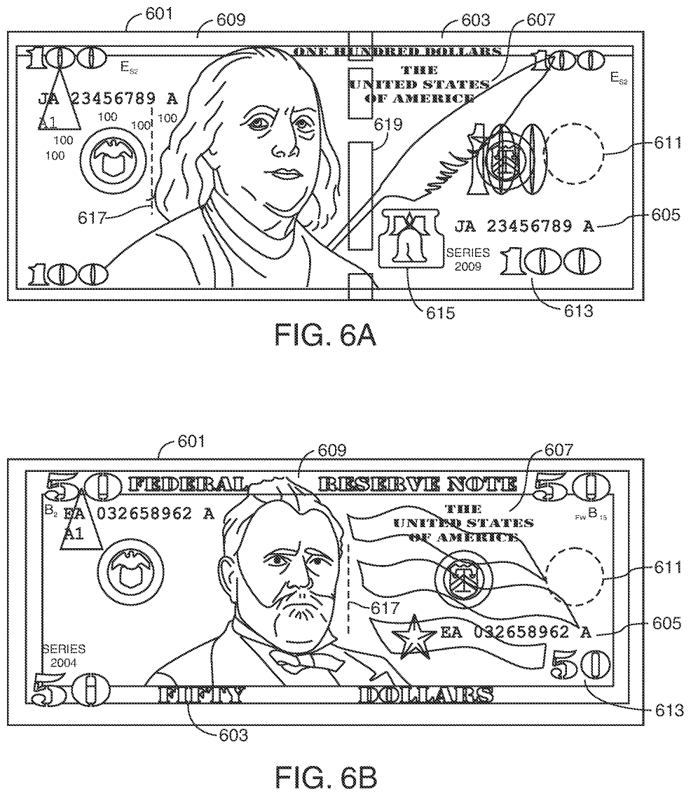

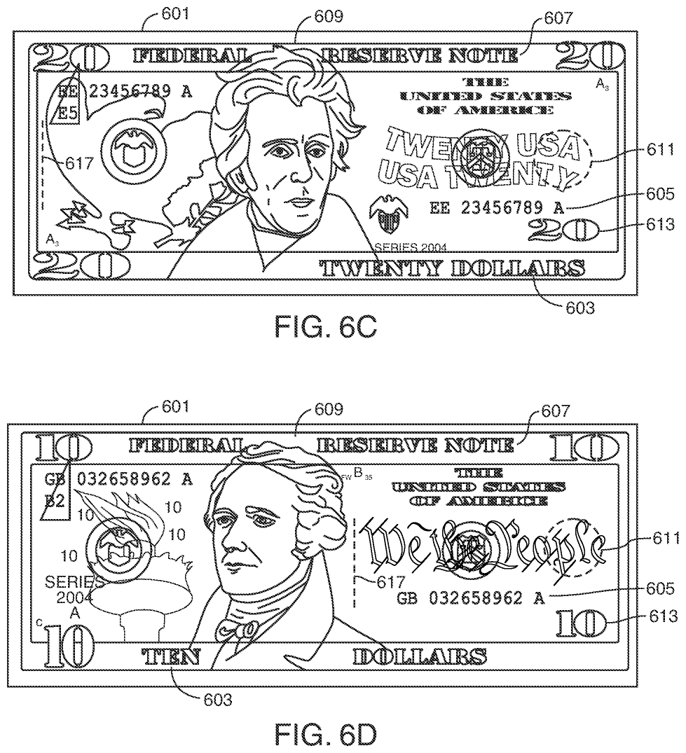

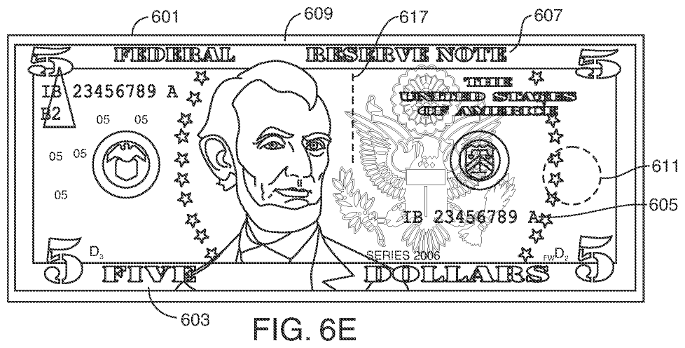

FIGS. 6A-6E show exemplary bills with a set of features according to aspects of the disclosure. Some of the features shown and described in FIGS. 6A-6E and in Tables A and B below were sourced from “https://www.secretservice.gov/sites/default/files/reports/2020-12/KnowYourMoney.pdf.” Illustrative features may include:
Red and blue fibers interspersed throughout a material included in the bill. The material may be off-white. The material may include a blend, e.g., the material may be substantially 25% linen and 75% cotton.
Alphanumeric Text indicating denomination, a serial number, and other suitable text such as “The United States of America” and “Federal Reserve Note.” See, e.g., numerical denomination text 601, alphabetical denomination text 603, serial number 605, and other text 607 shown in FIGS. 6A-6E.
Serial Numbers (605): Serial numbers may indicate the bill version. Federal reserve notes (FRNs) of series year 1996 and later may feature a first letter that corresponds to a specific series year, for example: E=2004, I=2006, L=2009A, G=2004A, J=2009.
Portraits and other Images: Each denomination and/or bill version may be associated with a unique portrait (e.g., a particular historical figure such as a President of the United States, as shown in 609 in in FIGS. 6A-6E) and/or other images. Some denominations and/or versions may include portraits that are enlarged and off-center without a frame.
Watermark: an image that may be visible from both faces of the bill. The image of the watermark may, for example be the same as the image in portrait 609. Application of light may assist in making the watermark visible. In particular, application of light to one face may assist in making the watermark visible from the other face. A watermark may be in a specific location depending on bill denomination and/or version. See, e.g., watermark location 611 shown in FIGS. 6A-6E.
Color-shifting ink (for $10, $20, $50 and $100) may shift from copper to green as the note is tilted. The color-shifting ink may, for example, be present in the lower right numeral 613 shown in FIGS. 6A-6D. The $100 bill may have a color-shifting “Bell in the Inkwell” image 615 shown in FIG. 6A.
Security Thread: may be a clear ribbon embedded vertically in the material. The thread may be inscribed with the denomination of the note and may only be visible when held to light. Each denomination may have a unique thread position (se, e.g, illustrative position 617 shown in FIGS. 6A-6E) and may glow a different color when held to ultraviolet (UV) light. For example, a $100 bill may glow light red/pink, a $50 may glow yellow, a $20 may glow green, a $10 may glow orange, and a $5 may glow blue.
$100 bill may feature a blue ribbon (619 shown in FIG. 6A) woven into the paper. The blue ribbon may include images of bells and/or “100”s. When the note is tilted back and forth, the bells and “100”s may appear to shift side to side. If the note is tilted side to side, they may appear to move up and down.
Microprinting: very small print that at first glance appears to be a solid line, but on closer inspection reveals tiny words and/or numbers. See Tables A and B below for illustrative examples of microprinting features.

Table A below shows some illustrative features that may be associated with certain bills. The bills included in Table A are of the “2004 Style” of Federal Reserve notes issued by the United States Treasury.

TABLE A

| | | | | | | Color- |
|---|---|---|---|---|---|---|
| | | | | | | Shifting Ink |
| | | | | | | in Front |
| | | | | | Other | Lower Right |
| $ | Portrait | Watermark | Thread | Microprinting | Microprinting | Numeral |
| 100 | Franklin | Franklin | Left of | “THE UNITED STATES OF | “ONE HUNDRED | Copper to |
| | | | Portrait | AMERICA” along Franklin's collar; | USA” along the | green. Also |
| | | | | small “100” in vertical borders; | golden quill; | appears in |
| | | | | “USA” along bottom of Franklin's | “USA 100” around | the bell in |
| | | | | portrait | the blank space | the inkwell |
| | | | | | containing the | |
| | | | | | portrait watermark | |
| 50 | Grant | Grant | Right | “THE UNITED STATES OF | “50,” “USA,” and | Copper to |
| | | | of | AMERICA” along Grant's collar | “FIFTY” in two | green |
| | | | Portrait | | blue stars to the | |
| | | | | | left of the portrait; | |
| | | | | | “FIFTY” along | |
| | | | | | side borders | |
| 20 | Jackson | Jackson | Left of | “THE UNITED STATES OF | “USA20” borders | Copper to |
| | | | Portrait | AMERICA 20 USA” in border | beginning part of | green |
| | | | | below treasurer's signature | text ribbon “USA | |
| | | | | | TWENTY,” rt side | |
| | | | | | of portrait | |
| 10 | Hamilton | Hamilton | Right | “THE UNITED STATES OF | “USA10” beneath | Copper to |
| | | | of | AMERICA” below portrait | torch to the left of | green |
| | | | Portrait | | the portrait; “TEN | |
| | | | | | DOLLARS” along | |
| | | | | | side border | |
| 5 | Lincoln | Lft: | Right | “E Pluribus Unum” at top of eagle's | On back, “USA | None |
| | | Vertical | of | shied to the rt. of portrait; “USA” btw | FIVE” on edge of | |
| | | “5, 5, 5” | Portrait | columns of eagle's shield; “FIVE | purple 5 | |
| | | Rt: large “5” | | DOLLARS” along side borders | | |

Table B below shows some specific features that are associated with certain bills. The bills included in Table B are of the “1996 Style” of Federal Reserve notes issued by the United States Treasury.

TABLE B

| | | | | | | Color- |
|---|---|---|---|---|---|---|
| | | | | | | Shifting Ink |
| | | | | | | in Front |
| | | | | | Other | Lower Right |
| $ | Portrait | Watermark | Thread | Microprinting | Microprinting | Numeral |
| 100 | Franklin | Franklin | Left of | “THE UNITED STATES OF | “USA 100 in lower | Green to |
| | | | Portrait | AMERICA” along Franklin's collar | left numeral | black |
| 50 | Grant | Grant | Right | “THE UNITED STATES OF | “FIFTY” along | Green to |
| | | | of | AMERICA” along Grant's collar | side borders | black |
| | | | Portrait | | | |
| 20 | Jackson | Jackson | Left of | “THE UNITED STATES OF | “USA20” in lower | Green to |
| | | | Portrait | AMERICA” in the lower oval | left numeral | black |
| | | | | framing of portrait | | |
| 10 | Hamilton | Hamilton | Right | “THE UNITED STATES OF | “TEN” in lower | Green to |
| | | | of | AMERICA” below portrait above | left numeral | black |
| | | | Portrait | Hamilton's name | | |
| 5 | Lincoln | Lincoln | Left of | “THE UNITED STATES OF | “FIVE | None |
| | | | Portrait | AMERICA” in the lower oval | DOLLARS” along | |
| | | | | framing of portrait | side borders | |

The steps of methods may be performed in an order other than the order shown and/or described herein. Embodiments may omit steps shown and/or described in connection with illustrative methods. Embodiments may include steps that are neither shown nor described in connection with illustrative methods.

Illustrative method steps may be combined. For example, an illustrative method may include steps shown in connection with another illustrative method.

Apparatus may omit features shown and/or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

The drawings show illustrative features of apparatus and methods in accordance with the principles of the invention. The features are illustrated in the context of selected embodiments. It will be understood that features shown in connection with one of the embodiments may be practiced in accordance with the principles of the invention along with features shown in connection with another of the embodiments.

One of ordinary skill in the art will appreciate that the steps shown and described herein may be performed in other than the recited order and that one or more steps illustrated may be optional. The methods of the above-referenced embodiments may involve the use of any suitable elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

Thus, methods and systems for cash verification and remote deposit are provided. Persons skilled in the art will appreciate that the present invention can be practiced by other than the described embodiments, which are presented for purposes of illustration rather than of limitation, and that the present invention is limited only by the claims that follow.

What is claimed is:

1. An apparatus for cash verification and remote deposit, said apparatus comprising:
a light;
a camera; and
a processor that has access to a database, said database comprising a set of features, wherein each feature from the set of features is associated with one or more bill denominations and bill versions;
wherein the processor is configured to:
receive credentials to authenticate a login of a user to a mobile app, said mobile app that is associated with a first financial entity;
receive an instruction from the user, via the mobile app, to deposit a bill of cash at a physical location associated with a second financial entity, said second financial entity that is different from the first financial entity;
illuminate, with the light, a front face of the bill;
capture, with the camera, an image of the illuminated front face;
illuminate, with the light, a back face of the bill;
capture, with the camera, an image of the illuminated back face;
extract, using image processing software, a first tier of features from the images, said first tier of features comprising:
an alphanumerical serial number;
an alphabetical representation of a bill denomination;
a numerical representation of the bill denomination; and
a portrait;
based on the first tier of features, determine a denomination and a version of the bill;
when the denomination exceeds a predetermined first threshold denomination and the version is within a predetermined range of versions, extract, using the image processing software, a second tier of features, said second tier of features comprising a watermark and a security thread;
when all of the extracted features are associated with the same denomination and version, and all of the features that are associated with said denomination and version are detected, verify the bill; and
when the bill is verified and a message is received, from the second financial entity, confirming that the second financial entity received the bill, deposit an amount corresponding to the denomination in an account, associated with the user, at the first financial entity.

2. The apparatus of claim 1 wherein, when the denomination exceeds a predetermined second threshold denomination, the processor is further configured to extract, using the image processing software, a third tier of features, said third tier of features comprising color shifting ink.

3. The apparatus of claim 2 wherein, when the denomination exceeds a predetermined third threshold denomination, the processor is further configured to extract, using the image processing software, a fourth tier of features, said fourth tier of features comprising a 3-dimensional security ribbon.

4. The apparatus of claim 1 wherein:
the light is configured to emit ultraviolet (UV) rays; and
the second tier of features further comprises a security thread that is able to be captured by the camera when illuminated by UV rays.

5. The apparatus of claim 1 further comprising a smart phone;
wherein the light, camera, and processor are disposed in a housing of the smart phone.

6. The apparatus of claim 1 wherein:
the light is a first light;
the apparatus further comprises a second light; and
the first light is configured to illuminate the front face, and the second light is configured to illuminate the back face while the first light is illuminating the front face.

7. The apparatus of claim 6 wherein:
the camera is a first camera;
the apparatus further comprises a second camera; and
the first camera is configured to capture the image of the front face, and the second camera is configured to capture the image of the back face while the first camera is capturing the image of the front face.

8. The apparatus of claim 6 further comprising a bill holder, the bill holder comprising:
a plate against which the bill is placed; and
a clip for securing the bill in place against the plate;
wherein:
the plate is configured to emit light; and
the plate is the second light.

9. The apparatus of claim 6 further comprising a smart phone;
wherein:
the first light, camera, and processor are disposed in a housing of the smart phone; and
the second light is configured to connect to the processor wirelessly via a Bluetooth or WiFi connection.

10. The apparatus of claim 6 further comprising a smart phone;
wherein:
the first light, camera, and processor are disposed in a housing of the smart phone; and
the second light is configured to connect to the processor with a wired connection that includes a universal serial bus (USB) port.

11. A method for cash verification and remote deposit, said method comprising:
receiving, at a processor, credentials to authenticate a login of a user to a mobile app, said mobile app that is associated with a first financial entity;
receiving, at the processor, an instruction from the user, via the mobile app, to deposit a bill of cash at a physical location associated with a second financial entity, said second financial entity that is different from the first financial entity;
illuminating, with a light, a front face of the bill;
capturing, with a camera, an image of the illuminated front face;
illuminating, with the light, a back face of the bill;
capturing, with the camera, an image of the illuminated back face;
extracting, using image processing software running on the processor, a first tier of features from the images, said first tier of features comprising:
an alphanumerical serial number;
an alphabetical representation of a bill denomination;
a numerical representation of the bill denomination; and
a portrait;
accessing a database that comprises a set of features, wherein each feature from the set of features is associated with one or more bill denominations and bill versions;
based on the first tier of features, determining a denomination and version of the bill;
when the denomination exceeds a predetermined first threshold denomination, and the version is within a predetermined range of versions, extracting, using the image processing software, a second tier of features, said second tier of features comprising a watermark and a security thread;
when all of the extracted features are associated with the same denomination and version, and all of the features that are associated with said denomination and version are detected, verifying the bill; and
when the bill is verified and a message is received, from the second financial entity, confirming that the second financial entity received the bill, depositing an amount corresponding to the denomination in an account, associated with the user, at the first financial entity.

12. The method of claim 11 further comprising, when the denomination exceeds a predetermined second threshold denomination, extracting, using the image processing software, a third tier of features, said third tier of features comprising color shifting ink.

13. The method of claim 12 further comprising, when the denomination exceeds a predetermined third threshold denomination, extracting, using the image processing software, a fourth tier of features, said fourth tier of features comprising a 3-dimensional security ribbon.

14. The method of claim 11 wherein:
the light is configured to emit ultraviolet (UV) rays; and
the second tier of features further comprises a security thread that is able to be captured by the camera when illuminated by UV rays.

15. The method of claim 11 wherein the light, camera, and processor are disposed in a housing of a smart phone.

16. The method of claim 11 further comprising, when the light is a first light, illuminating the front face with the first light, while illuminating the back face with a second light.

17. The method of claim 16 further comprising, when the camera is a first camera, capturing the image of the front face with the first camera, while capturing the image of the back face with a second camera.

18. The method of claim 16 further comprising:
placing the bill against a plate that is configured to emit light and is the second light; and
securing the bill in place against the plate with a clip.

19. The method of claim 16 wherein:
the first light, camera, and processor are disposed in a housing of a smart phone; and
the second light is configured to connect to the processor wirelessly via a Bluetooth or WiFi connection.

20. The method of claim 16 wherein:
the first light, camera, and processor are disposed in a housing of a smart phone; and
the second light is configured to connect to the processor with a wired connection that includes a universal serial bus (USB) port.
